(19) United States
(12) Patent Application Publication
(10) Pub. No.: US 2013/0260805 A1
(43) Pub. Date: Oct. 3, 2013

(54) APPARATUS AND METHOD FOR CONTROLLING CELL TRANSMIT POWER TO REDUCE INTERFERENCE OF CELL AND MOBILE TELECOMMUNICATION BASE STATION FOR THE SAME

(71) Applicants: Byoung Seong PARK, Incheon (KR); Jung Seung LEE, Uiwang-si (KR)

(72) Inventors: Byoung Seong PARK, Incheon (KR); Jung Seung LEE, Uiwang-si (KR)

(21) Appl. No.: 13/435,435

(22) Filed: Mar. 30, 2012

(51) Int. Cl. H04W 52/30; H04B 15/00

(52) U.S. Cl. 455/501; 455/561

(57) ABSTRACT

Provided are an apparatus and method for controlling transmit power of a base station and a mobile communication base station using the same, which can control transmission power for minimizing interference from the base station to a cell adjacent thereto. When a power amplifier outputs the minimum value of a power range restricted by a dynamic range in consideration of an offset against a lowest value of an output power, a comparator compares an optimal transmit power of the base station and the minimum value of a power range restricted by the dynamic range, and an attenuator attenuates the output power value of the power amplifier according to the comparison result.

### TECHNICAL FIELD

The present disclosure relates to a mobile communication technology field, and particularly, to an apparatus and method for controlling transmit power of a base station and a mobile communication base station using the same, which can control transmit power for minimizing interference from the base station to a neighbor cell.

### BACKGROUND

With rapid developments in communications, computer networks and semiconductor technologies, a variety of services are provided using wireless communication networks. Not only that, users are requiring higher-level services and wireless interne service market around the world is growing explosively. To accommodate these trends, a mobile communication system using a wireless communication network is being evolved to provide a multimedia communication service transmitting various data in addition to a voice service.

Recently, wireless data services through code division multiple access (CDMA) 2000, evolution data only (EV-DO), wideband CDMA (WCDMA) and wireless local area networks (WLANs) have been commercialized. Thus, the residential use of mobile phones and the demand for mobile data at home have increased steadily. To keep up with such trend, a method for providing mobile communication services by installing a small cell base station indoors has been proposed so as to access a core network of the mobile communication system through an indoor broadband network. Particularly in a next-generation network system, a method of disposing a number of small size cells (e.g., femto-cells) has been proposed to meet the demand for a high data transmission rate and facilitate stable and reliable providing of various services. A small cell base station covering such small size cells may otherwise be referred to as an indoor base station or a small cell base station and a Home-eNB, a HeNB or the like in the 3rd Generation Partnership Project (3GPP). As such, by reducing the size of the cell to be served in an indoor environment, efficiency of the next-generation network system using a high frequency band can be improved. Further, using a number of small size cells is advantageous in that the number of times of frequency reuse can be increased. Also, such small-size multiple cells using scheme offer an advantage of improving the deteriorated channel status due to radio wave attenuation which is caused by controlling the entire cell area with only one base station. The scheme also offers the advantage of enabling services to a user in a shadow area, which used to be impossible. Based on these advantages, a scheme of combining a conventional macro-cell (a cell area controlled by an outdoor base station) and a femto-cell (a cell area controlled by a small cell base station such as an indoor base station, a small cell base station and the like) is newly devised and is drawing attention.

When a multi-cell, which is used for improving the link performance of a user in an adjacent area to or an overlapped area with a macro-cell, operates at a frequency band equal to that of a neighbor macro-cell, interference may be caused to a user using a neighbor macro-cell on a downlink, and thus, it is required to use the multi-cell at a low power or control transmit power of the multi-cell by using downlink interference which has been predicted. In this case, even though the transmit power of the multi-cell is optimized, an actually transmitted power may become higher than the power that is optimized by the dynamic range of a power amplifier for a multi-cell, causing the increase of interference to a user using a neighbor macro-cell. The dynamic range denotes a power level range of an input signal that is clearly detected by a receiver without distortion.

As an example, the transmit power of a femto-cell is capable of being fixed irrespective of a location at which the femto-cell is installed, but since the femto-cell causes interference to a user using a neighbor macro-cell or a femto-cell and thereby degrades system performance, the transmit power of the femto-cell is required to be adjusted for minimizing interference. However, since a range enabling the change of a transmit power is restricted according to the dynamic range of the femto-cell power amplifier (for example, according to the Long Term Evolution (LTE) standard of 3rd Generation Partnership Project (3GPP), the dynamic range of a base station output has been defined to have a minimum of 17 dB at a bandwidth of 10 MHz), a signal is transmitted in a power having a level higher than a desired transmit power, causing interference to a user using an neighbor cell. Also, when the power of the femto-cell is excessive, interference to a user using a neighbor macro-cell or femto-cell increases, and thus, the performance of a neighbor cell is degraded.

### SUMMARY

The present disclosure provides some embodiments of an apparatus and method for controlling a transmit power of a base station and a mobile communication base station using the same, which can control the transmit power for minimizing interference from the base station to a cell neighbor thereto.

According to an aspect of the present disclosure, provided are an apparatus and method for controlling a transmit power of a base station and a mobile communication base station using the same, which can control the transmit power for minimizing interference from the base station to a cell adjacent thereto. According to the present disclosure, when a power amplifier outputs the minimum value of a range restricted by a dynamic range in consideration of an offset against a lowest value of an output, a comparator compares a optimal transmit power of the base station with the minimum value of a range restricted by the dynamic range, and an attenuator attenuates and outputs the output value of the power amplifier according to the comparison result. When the compared result shows that the optimal transmit power “Pₒₚₜ” of the base station where link performance and interference to an neighbor cell are minimized is less than a minimum output power value “P_{femto,max}−Δ” of the power amplifier restricted by the dynamic range (i.e., Pₒₚₜ [symbol] P_{femto,max}−Δ), by adjusting the attenuation amount “G” of the attenuator, the transmit power range “(P_{lower}, Pᵤₚₚₑᵣ)” of an output value “P_{femto}” is set as following Equation (1):

(P_{lower},Pᵤₚₚₑᵣ)=(P_{femto,max}−G−Δ,P_{femto,max}−G) (1)

When G=max(P_{femto,max}−Δ−Pₒₚₜ+α, 0) and Pₒₚₜ [symbol] P_{femto,max}−Δ, the output power value “P_{femto}” is adjusted to become the optimal transmit power “Pₒₚₜ” (i.e., P_{femto}=Pₒₚₜ) of the base station, the offset “a” against the lowest value of the output power allows the output power value “Pₜ” of the power amplifier to be within an output range after the output value “Pt” passes through the attenuator, has a range “(0, Δ)”, and is set as following Equation (2) according to the range of the optimal transmit power “Pₒₚₜ” of the base station:

if Pₒₚₜ≧P_{femto,max}−Δ,α=min(Pₒₚₜ−(P_{femto,max}−Δ),Δ)

else αε(0,Δ) (2)

### BRIEF DESCRIPTION OF THE DRAWINGS

FIG. 1 is a diagram illustrating an exemplary configuration of a mobile communication network to which the present disclosure may be applied.

FIG. 2 is a diagram illustrating cell interference in a mobile communication network.

FIG. 3 is a diagram showing an optimal value of a transmit power.

FIG. 4 is a diagram showing an actual transmit power of a base station before control of a transmit power.

FIG. 5 is a diagram illustrating a configuration of an apparatus for controlling a transmit power of a base station, according to an embodiment of the present disclosure.

FIG. 6 is a diagram showing an actual transmit power of a base station after control of a transmit power, according to an embodiment of the present disclosure.

FIG. 7 is a diagram showing a transmit power distribution of a base station according to an embodiment of the present disclosure.

FIG. 8 is a diagram showing a reception Signal to Interference and Noise Ratio (SINR) distribution of a user using a neighbor cell, based on use of an adaptive attenuator, according to an embodiment of the present disclosure.

### DETAILED DESCRIPTION

Hereinafter, embodiments of the present disclosure will be described in detail with reference to the accompanying drawings. However, detailed descriptions related to well-known functions or configurations will be ruled out in order not to unnecessarily obscure subject matters of the present disclosure.

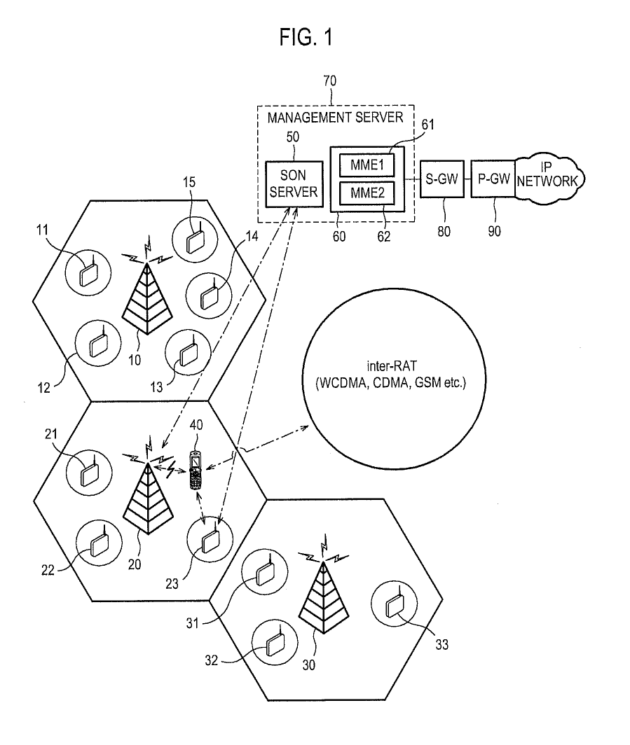

FIG. 1 is a diagram illustrating an exemplary configuration of a mobile communication network to which the present disclosure may be applied.

In an embodiment, for example, the mobile communication network may include Global System for Mobile communication (GSM) network, 2G mobile communication network such as CDMA, LTE network, wireless Internet such as WiFi, portable Internet such as Wireless Broadband Internet (WiBro) and World Interoperability for Microwave Access (WiMax), a mobile communication network (e.g., 3G mobile communication network such as WCDMA or CDMA2000, 3.5G mobile communication network such as High Speed Downlink Packet Access (HSDPA) or High Speed Uplink Packet Access (HSUPA), or 4G mobile communication network that is currently providing service, or the like) that supports the transmission of a packet and other arbitrary mobile communication networks that include a macro base station (Macro-eNB), a small cell base station (femto-cell or HeNB (Home-eNB)), and User Equipment (UE), but the mobile communication network may not be limited thereto. Hereinafter, on the embodiment will be described mainly in the context of E-UTRAN that is the LTE wireless access network.

As illustrated in FIG. 1, the mobile communication network may be configured with one or more network cells, and different network cells may be included in the mobile communication network. The mobile communication network may include a plurality of small cell base stations (Home-eNB) 11 to 15, 21 to 23 and 31 to 33, which manage small network cells (for example, femto-cells, etc.), a plurality of macro base stations (Macro-eNB or eNB) 10, 20 and 30, which manage wide range cells (for example, macro-cells, etc.), user equipment (UE) 40, a Self Organizing & optimizing Networks (SON) server 50, a Mobility Management Entity (MME) 60, a Serving Gateway (S-GW) 80, and a PDN Gateway (P-GW) 90. The number of elements illustrated in FIG. 1 is exemplary, and the number of elements of the mobile communication network for implementing the present invention may not be limited thereto.

The macro base stations (Macro-eNB or eNB) 10, 20 and 30, for example, may include a feature of a macro-cell base station that manages a cell having a radius of about 1 km, which may be allowed to be used in LTE network, WiFi network, WiBro network, WiMax network, WCDMA network, CDMA network, UMTS network, and GSM network, but the present embodiment is not limited thereto.

The small cell base stations (Home-eNB) 11 to 15, 21 to 23 and 31 to 33, may include the features of an indoor base station and a femto base station that manage, for example, a cell having a radius of several tens meters, which are allowed to be used, for example, in LTE network, WiFi network, WiBro network, WiMax network, WCDMA network, CDMA network, UMTS network, and GSM network, but the small cell base station may not be limited thereto.

The small cell base stations 11 to 15, 21 to 23 and 31 to 33 and the macro base stations 10, 20 and 30 may have independent connectivity to a core network, respectively.

The UE 40 may have features of a wireless mobile terminal used in a 2G mobile communication network such as a GSM network and a CDMA network, a wireless internet network such as a LTE network and a WiFi network, a portable internet network such as a WiBro network and a WiMax network and a mobile communication network supporting packet transport. However, the UE 40 may not be limited thereto.

A operation and management (O&M) server 70, which is a network management apparatus of the small cell base station, is configured to perform management of the small cell base stations 11 to 15, 21 to 23 and 31 to 33 and the macro base stations (Macro-eNB or eNB) 10, 20 and 30 and configuration information thereof. The O&M server 70 may perform functions of both the SON server 50 and the MME 60. The SON server 50 may includes an arbitrary server, which may perform installation and optimization of the macro base station and the small cell base station and function to provide basic parameters or data necessary for the respective base stations. The MME 60 may include an arbitrary entity for managing the mobility of the UE 40. Also, each of MMEs 61 and 62 may perform a function of a Base Station Controller (BSC), and perform resource allocation, call control, handover control, audio processing, and packet processing for a base station (pico eNB, HeNB, macro eNB, etc.) connected thereto.

In an embodiment, the one network management server 70 may perform the function of the SON server 50 and the function of the MME 60. The SON server 50 and the MME 60 may be configured to manage one or more macro base stations 10, 20 and 30 and one or more small cell base stations 11 to 15, 21 to 23 and 31 to 33.

Although it is assumed that the network cells are in a mixed form of the macro cells and femto-cells in the above mobile communication network, it may be possible that the network cells are configured only with either the macro cells or the femto-cells.

Assuming that the above-described mobile communication network is a LTE network, the LTE network may interwork with inter-RAT networks (e.g., WiFi network, WiBro network, WiMax network, WCDMA network, CDMA network, UMTS network, GSM network and the like). When one of the inter-RAT networks is the mobile communication network, the mobile communication network may also interwork with the other networks (LTE network, WiFi network, WiBro network, WiMax network, WCDMA network, CDMA network, UMTS network, GSM network and the like). Although one of the networks (for example, LTE network) is illustrated as being separated from the other networks (LTE network, WiFi network, WiBro network, WiMax network, WCDMA network, CDMA network, UMTS network, GSM network and the like) in the drawing, the present embodiment is based on the premise that one type of network and the other types of networks are overlaid with each other

Although it is described above that the network cell is assumed as the macro-cell or/and the femto-cell, the network cell may include a cell that is managed by a micro base station, a pico base station, and a relay for cell expansion. The present disclosure is used to control transmission power for minimizing interference from a base station (macro base station, micro base station, pico base station, small cell base station, relay or the like), which manages a network cell, to a neighbor cell.

In LTE network, an access to the macro-cell is allowed to all user equipments, but an access to a femto-cell may be allowed for limited specific user equipments (subscribers). Hereinafter, an access procedure of the user equipment 40 will be described based on a small cell base station 21. The access procedure may be identically applied to the small cell base stations 11 to 15, 21 to 23 and 31 to 33 having the same configuration as that of the small cell base station 21.

The small cell base station 21 may broadcast a System Information Block type 1 (SIB 1) that is information on a femto-cell which is managed by itself, wherein the SIB 1 includes a Closed Subscriber Group (CSG) indicator that indicates whether an access to a corresponding femto-cell is restricted. When the CSG indicator in the SIB 1 broadcasted by the small cell base station 21 has a true value, a communication is performed in a closed type that allows only a specific subscriber to access a corresponding femto-cell (CSG), but when the CSG indicator has a false value, a communication is performed in an open type that allows all subscribers to access the corresponding femto-cell (OSG). When the CSG indicator has a true value, the user equipment 40 may check whether the femto-cell is included in a white list, which is a list of femto cells accessible to the user equipment 40, and access a corresponding femto-cell, only if it is confirmed that the corresponding femto-cell is included.

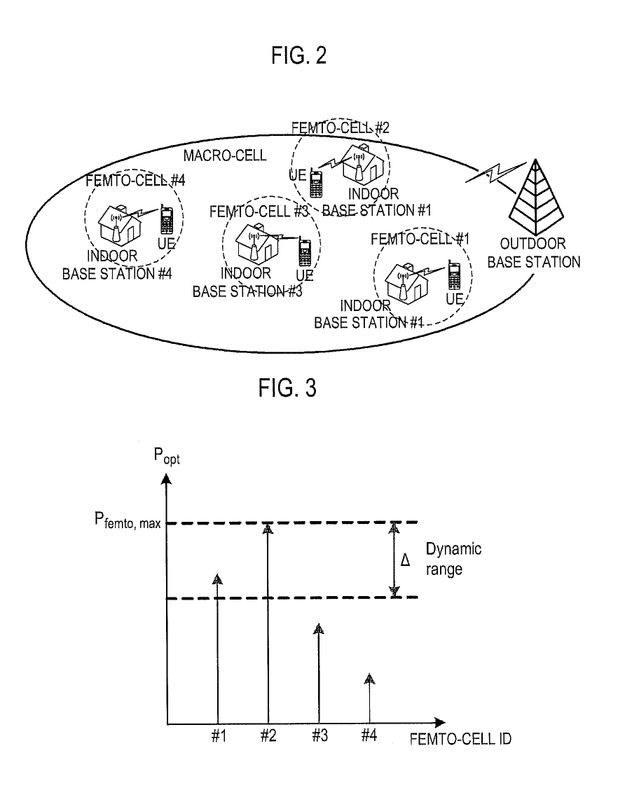

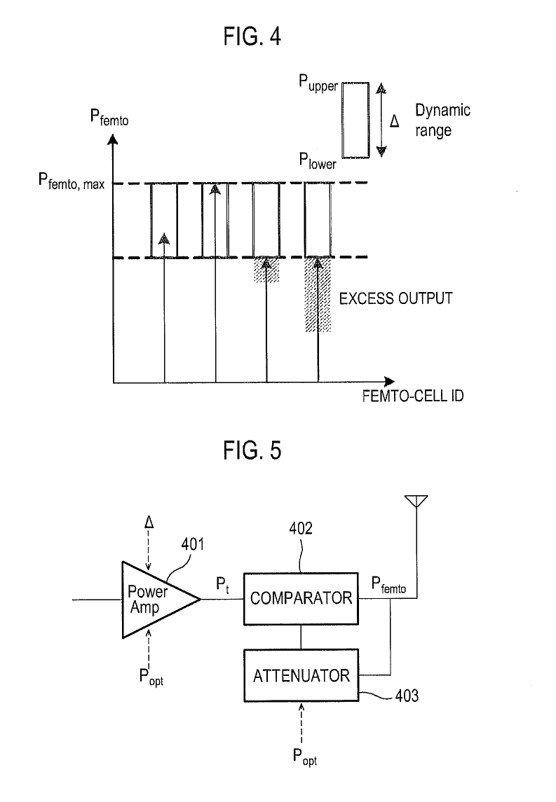

Accordingly, the user equipment 40 that has failed to access a femto-cell in a macro-cell area accesses a macro-cell. In an embodiment of the present disclosure, as illustrated in FIG. 2, a base station (small cell base station) of a femto-cell that operates within a macro-cell causes interference to a neighboring macro-cell user (i.e., a user equipment accessed to a macro base station). In this case, the small cell base station may secure link performance targeted in the femto-cell and optimize a femto-cell transmit power so as to minimize interference to neighboring users, in consideration of ambient interference on the femto-cell, as shown in FIG. 3. However, the actual transmit power of each small cell base station is not an optimized value but a value that is restricted by the dynamic range of a power amplifier as shown in FIG. 4.

Assuming that an optimal femto-cell transmit power, at which the link performance of a femto-cell user and interference to an adjacent macro-cell are minimized, is “Pₒₚₜ”, the maximum output power “P_{femto,max}” of a power amplifier 401 (see FIG. 5) and a femto-cell transmit power “P_{femto}” having a dynamic range “Δ” are determined as expressed in Equation (1), Equation (1) is based on the assumption that a femto-cell transmission apparatus does not include an attenuator 403 (see FIG. 5):

If Pₒₚₜ [symbol] P_{femto,max},P_{femto}=P_{femto,max}

else if Pₒₚₜ [symbol] P_{femto,max}−Δ,P_{femto}=P_{femto,max}−Δ

else P_{femto}=Pₒₚₜ (1)

In this case, if the femto-cell transmit power “Pₒₚₜ” optimized for minimizing the interference becomes much smaller than “P_{femto,max}−Δ”, a femto-cell transmit power, which is actually transmitted, becomes higher than an optimal output power, so that interference to a user, which does not access to the femto-cell (i.e., a user equipment accessed to a macro-cell), may be increased.

If a femto-cell transmit power optimized under the interference circumstance of FIG. 2 is indicated as shown in FIG. 3, the transmit power of femto-cells #3 and #4, which get out of the dynamic range “Δ” (as a case of which Pₒₚₜ [symbol] P_{femto,max}−Δ, P_{femto}=P_{femto,max}−Δ) are transmitted higher than an optimal output power, and thus, interference intensity may more affect a user using the neighbor cell, which may cause the degradation of downlink performance of the neighbor cell. Where Pₒₚₜ [symbol] P_{femto,max} and Pₒₚₜ [symbol] P_{femto,max}−Δ (corresponding to femto-cells #1 and #2) in Equation (1), the femto-cell transmit power “P_{femto}” becomes the optimal femto-cell transmit power “Pₒₚₜ”.

Therefore, in the present embodiment, as illustrated in FIG. 5, an adaptive attenuator 403 is disposed at a rear end of the power amplifier 401 in the femto-cell transmission apparatus, and controls the transmit power of the power amplifier 401.

When the optimal femto-cell transmit power where the link performance of a femto-cell user and interference to an adjacent macro-cell are minimized is “Pₒₚₜ”, an output “Pₜ” that passes through the power amplifier 401 restricted within the dynamic range “Δ” is determined as expressed in Equation (2).

Pₜ=P_{femto,max}−Δ+α (2)

Herein, a constant offset (dB) “α” of the adaptive attenuator 403, which is an offset against the lowest value of the output allowing the output power to be within an output power range after the output Pₜ passes through the adaptive attenuator 403, has a range of (0, Δ) and is determined as expressed in Equation (3), according to the range of “Pₒₚₜ”.

if Pₒₚₜ≧P_{femto,max}−Δ,α=min(Pₒₚₜ−(P_{femto,max}−Δ),Δ)

else αε(0,Δ) (3)

If the comparison result of a comparator 402 shows “Pₒₚₜ≧P_{femto,max}−Δ”, that is, Pₒₚₜ is within a transmit power range even without the adjustment of the attenuator 403, then α=Pₒₚₜ−(P_{femto,max}−Δ) and thus a becomes an offset against a minimum output “P_{femto,max}−Δ”. That is, if Pₒₚₜ≧P_{femto,max}−Δ, then the femto-cell transmit power “P_{femto}” becomes the optimized femto-cell transmit power “Pₒₚₜ”. Also, if the comparison result of the comparator 402 shows “Pₒₚₜ≧P_{femto,max}”, that is, Pₒₚₜ gets out of a P_{femto,max} range, then α=Δ and thus it is limited that Pₒₚₜ=P_{femto,max}. That is, if Pₒₚₜ≧P_{femto,max}, then the femto-cell transmit “P_{femto}” is outputted in a limited value that Pₒₚₜ=P_{femto,max}. However, if the power comparison result of the comparator 402 shows “Pₒₚₜ [symbol] P_{femto,max}−Δ”, that is, Pₒₚₜ gets out of the transmit power range of the power amplifier 401 to thereby require the adaptive attenuator 403, then a is set to an arbitrary value within “αε(0, Δ)” and then attenuation amount “G” of the adaptive attenuator 403 is adjusted such that a transmit power after passing the adaptive attenuator 403 has an offset of a against the lowest value of the output.

The femto-cell transmit power “P_{femto}”, which is obtained by passing the output Pₜ of the power amplifier 401 via the adaptive attenuator 403, is expressed as Equation (4) below:

P_{femto}=Pₜ−G (4)

In this case, the attenuation amount (dB) “G” of the adaptive attenuator 403 is determined as expressed in Equation (5) below. If Pₒₚₜ [symbol] P_{femto,max}−Δ, then the attenuation amount “G” of the adaptive attenuator 403 is adjusted such that the output power “P_{femto}” outputted from the adaptive attenuator 403 becomes equal to Pₒₚₜ:

G=max(P_{femto,max}−Δ−Pₒₚₜ+α,0) (5)

Therefore, a femto-cell transmit power has an output range “(P_{lower}, Pᵤₚₚₑᵣ)” that is as expressed in Equation (6) below, and is optimized irrespective of the dynamic range “Δ” of the power amplifier 401. In Equation (6) below, Pᵤₚₚₑᵣ is the highest value of the femto-cell transmit power, and P_{lower} is the lowest value of the femto-cell transmit power:

(P_{lower}=)P_{femto,max}−G−Δ≦P_{femto}≦P_{femto,max}−G(=Pᵤₚₚₑᵣ) (6)

Looking into an operation of controlling the femto-cell transmit power, the femto-cell transmit power under the femto-cell interference circumstance of FIG. 2 is optimized as shown in FIG. 3. This is a known technology.

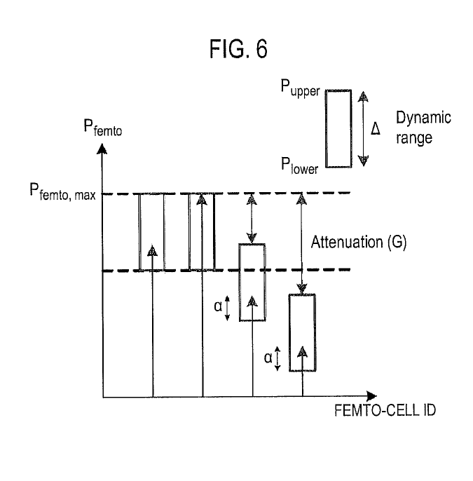

Subsequently, it is determined whether the optimized value is within the dynamic range to determine an amount of attenuation. That is, in the femto-cells #1 and #2 that lies within the dynamic range, the attenuation amount “G” of the adaptive attenuator 403 becomes 0 dB through Equation (5) (in this case, the femto-cell transmit power range becomes that (P_{lower}, Pᵤₚₚₑᵣ)=(P_{femto,max}−Δ, P_{femto,max})). (In the femto-cells #3 and #4 that become out of the dynamic range, the femto-cell transmit power “P_{femto}” lies within the transmit power range “(P_{lower}, Pᵤₚₚₑᵣ)=(P_{femto,max}−G−Δ, P_{femto,max}−G)” based on the attenuation amount “G” of the adaptive attenuator 403, so that P_{femto}=Pₒₚₜ. As a result, the femto-cell transmit power “P_{femto}” outputted from the adaptive attenuator 403 is indicated as shown in FIG. 6.

In order to test the effects of the present disclosure, a simulation has been performed by the following method.

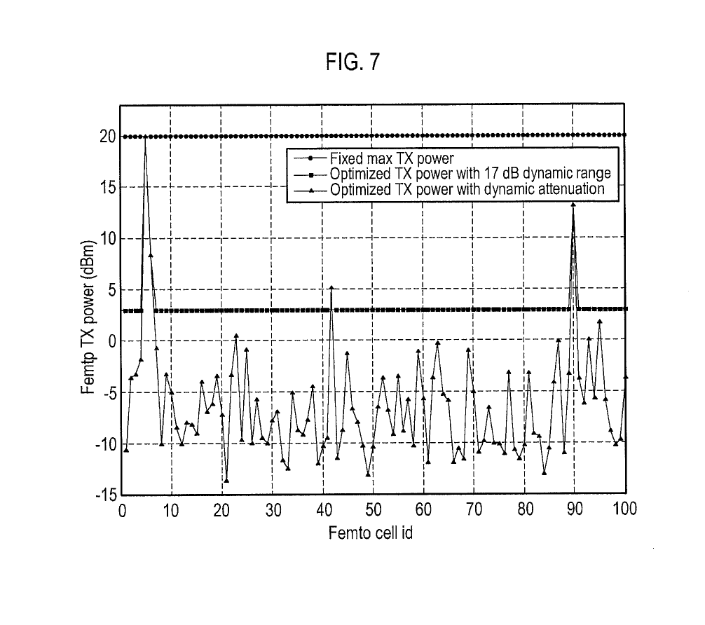

FIG. 7 shows the transmission power distributions of 100 femto-cells that are disposed in one macro-cell, on the assumption that “P_{femto,max}=20 dB and Δ=17 dB”. When the adaptive attenuator 403 is not used, a transmit power is restricted by the dynamic range of the power amplifier 401, thereby outputting power higher than the optimal power. On the contrary, when the adaptive attenuator 403 is used, an actual femto-cell transmit power is adjusted to the optimal output power, thus improving the link performance of a user using an neighbor cell.

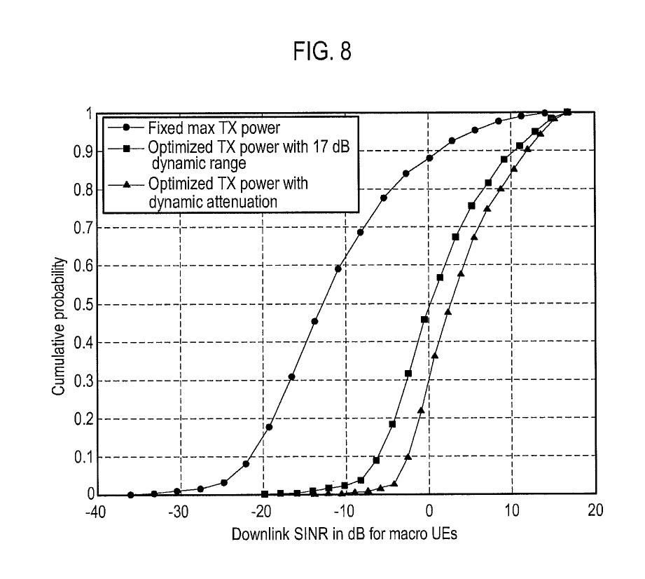

FIG. 8 shows the reception Signal to Interference and Noise Ratio (SINR) distribution of a user using an neighbor cell, depending on whether the adaptive attenuator 403 is used or not. As shown in FIG. 8, when the adaptive attenuator 403 is used, a higher SINR distribution can be secured, and thus, link performance can be improved. To quantitatively provide a description on this, as shown in Table 1 below, when it is assumed that the minimum requirement for maintaining a call is “SINR=−10 dB”, a call fail rate has been improved from 2.4% to 0.3%, the downlink frequency efficiency of a user using an adjacent macro-cell has been increased from 0.92 bps/Hz to 1.19 bps/Hz.

TABLE 1

| | | Optimized | |
|---|---|---|---|
| | | without | Optimized with |
| | Fixed max TX | dynamic | dynamic |
| | power | attenuation | attenuation |
| Outage probability | 62.1% | 2.4% | 0.3% |
| @ target SINR = −10 dB | | | |
| Average macro user | 0.20 | 0.92 | 1.19 |
| spectral efficiency in | | | |
| bps/Hz | | | |

In the above embodiment, a description has been made on the assumption of interference that is caused from a femto-cell to a macro-cell, but the present disclosure is not limited thereto. That is, even when a femto-cell, a pico-cell, a micro-cell, a macro-cell, and a relay cause interference to a cell adjacent thereto, the present disclosure may be applied identically. In this case, the femto-cell transmit power “P_{femto}” and the maximum output “P_{femto,max}” of the power amplifier may be generalized as the P_{cell} and P_{cell,max} of a multi-cell.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An apparatus for controlling a transmit power of a base station, the apparatus comprising:
a power amplifier configured to output a minimum value of a power range restricted by a dynamic range, in consideration of an offset against a lowest value of an output power;
a comparator configured to compare a predetermined base station transmit power with the minimum value restricted by the dynamic range; and
an attenuator configured to attenuate a power of the power amplifier according to the comparison result of the comparator.

2. The apparatus of claim 1, wherein when the predetermined base station transmit power in which link performance and interference to an neighbor cell are minimized is Pₒₚₜ, the output value “Pₜ” of the power amplifier is set by following Equation (1),
Pₜ=P_{femto,max}−Δ+α (1)
where P_{femto,max} is a maximum output power of the power amplifier, Δ is a dynamic range of the power amplifier, and α an offset against the lowest value of the output power.

3. The apparatus of claim 2, wherein the offset “a” against the lowest value of the output power is to allow the output value “Pₜ” to be within an output power range after passing the attenuator, has a range of (0, Δ), and is set by following Equation (2) according to a range of the predetermined transmit power “Pₒₚₜ” of the base station:
if Pₒₚₜ≧P_{femto,max}−Δ,α=min(Pₒₚₜ−(P_{femto,max}−Δ),Δ)
else αε(0,Δ) (2).

4. The apparatus of claim 3, wherein, if the comparison result shows that the optimal transmit power “Pₒₚₜ” of the base station is less than the minimum value “P_{femto,max}−Δ” of the power range restricted by the dynamic range (i.e., Pₒₚₜ [symbol] P_{femto,max}−Δ), by adjusting an amount “G” of attenuation, then the attenuator sets an output power value “P_{femto}” thereof by following Equation (3):
P_{femto}=Pₜ−G (3)
where when G=max(P_{femto,max}−Δ−Pₒₚₜ+a, 0) and Pₒₚₜ [symbol] P_{femto,max}−Δ, the output power value “P_{femto}” outputted from the attenuator is adjusted to become the optimal transmit power “Pₒₚₜ” of the base station (i.e., P_{femto}=Pₒₚₜ).

5. The apparatus of claim 4, wherein the output power value “P_{femto}” outputted from the attenuator has a transmit power range “(P_{lower}, Pᵤₚₚₑᵣ)” as following Equation (4):
(P_{lower}=)P_{femto,max}−G−Δ≦P_{femto}≦P_{femto,max}−G(=Pᵤₚₚₑᵣ) (4).

6. The apparatus of claim 1, wherein the base station is a small cell base station which manages a femto-cell.

7. A mobile communication base station, comprising: the base station transmit power control apparatus of claim 1, the mobile communication base station variably attenuating a maximum output power at a transmission end thereof.

8. The mobile communication base station of claim 7, wherein, when the maximum output power is variably attenuated, in case that a predetermined transmit power “Pₒₚₜ” of the base station in which link performance and interference to an neighbor cell are minimized is less than a maximum power value “P_{femto,max}” of the power amplifier restricted by the dynamic range “Δ” (i.e., Pₒₚₜ [symbol] P_{femto,max}−Δ), a transmit power range “(P_{lower}, Pᵤₚₚₑᵣ)” of an output power value “P_{femto}” is set as following Equation (1) by adjusting an attenuation amount “G” of the attenuator:
(P_{lower},Pᵤₚₚₑᵣ)=(P_{femto,max}−G−Δ,P_{femto,max}−G) (1)
where when G=max(P_{femto,max}−Δ−Pₒₚₜ+α, 0) and Pₒₚₜ [symbol] P_{femto,max}−Δ, the output power value “P_{femto}” is adjusted to become the optimal transmit power “Pₒₚₜ” of the base station (i.e., P_{femto}=Pₒₚₜ), an offset “a” against the lowest value of the output power allows the output power value “Pt” of the power amplifier to be within an output power range after the output power value “Pt” passes through the attenuator, has a range “(0, Δ)”, and is set as following Equation (2) according to the range of the optimal transmit power “Pₒₚₜ” of the base station:
if Pₒₚₜ≧P_{femto,max}−Δ,α=min(Pₒₚₜ−(P_{femto,max}−Δ),Δ)
else αε(0,Δ) (2).

9. A method of controlling transmit power of a base station, the apparatus comprising:
a) outputting a minimum value of a power range restricted by a dynamic range, in consideration of an offset against an lowest value of an output;
b) comparing a predetermined base station transmit power with the minimum value of the power range restricted by the dynamic range; and
c) attenuating, by an attenuator, an output power value of the power amplifier according to the comparison result.

10. The method of claim 9, wherein, when the predetermined transmit power of the base station in which link performance and interference to an neighbor cell are minimized is Pₒₚₜ, an output value “Pₜ” at the a) is set as following Equation (1):
Pₜ=P_{femto,max}−Δ+α (1)
where P_{femto,max} is a maximum output of the power amplifier; Δ is a dynamic range of the power amplifier; a is an offset against a lowest value of the output lower value; and the offset “α” against the lowest value of the output power allows the output power value “Pₜ” to be within an output power range after the output power value “Pt” passes through the attenuator, has a range “(0, Δ)”, and is set as following Equation (2) according to the range of the optimal transmit power “Pₒₚₜ” of the base station:
if Pₒₚₜ≧P_{femto,max}−Δ,α=min(Pₒₚₜ−(P_{femto,max}−Δ),Δ)
else αε(0,Δ) (2).

11. The method of claim 10, wherein, at the c), when the compared result shows that the optimal transmit power “Pₒₚₜ” of the base station is less than the minimum value “P_{femto,max}−Δ” of the power range restricted by the dynamic range (i.e., Pₒₚₜ [symbol] P_{femto,max}−Δ), by adjusting an amount “G” of attenuation, an output power value “P_{femto}” is set as following Equation (3):
P_{femto}=Pₜ−G (3)
where when G=max(P_{femto,max}−Δ−Pₒₚₜ+α,0) and Pₒₚₜ [symbol] P_{femto,max}−Δ, the output power value “P_{femto}” outputted from the attenuator is adjusted to become the optimal transmit power “Pₒₚₜ” of the base station (i.e., P_{femto}=Pₒₚₜ).

12. The method of claim 11, wherein, the output power value “P_{femto}” at the c), has a transmit power range“(P_{lower},Pᵤₚₚₑᵣ)” which is expressed by the following Equation (4):
(P_{lower}=)P_{femto,max}−G−Δ≦P_{femto}≦P_{femto,max}−G(=Pᵤₚₚₑᵣ) (4).

13. The method of claim 9, wherein the base station is a small cell base station which manages a femto-cell.
